(19) United States
(12) Patent Application Publication
(10) Pub. No.: US 2015/0032809 A1
(43) Pub. Date: Jan. 29, 2015

(54) Conference Session Handoff Between Devices

(71) Applicant: Cisco Technology, Inc., San Jose, CA (US)

(72) Inventors: Delei Xie, HeFei (CN); Ye Wang, HeFei (CN); Ruwei Liu, HeFei (CN); Mark T. Oden, Mountain View, CA (US)

(73) Assignee: Cisco Technology, Inc., San Jose, CA (US)

(21) Appl. No.: 13/951,804

(22) Filed: Jul. 26, 2013

(51) Int. Cl. H04L 29/06

(52) U.S. Cl. CPC H04L 65/403
USPC 709/204

(57) ABSTRACT

In an online conference between a plurality of client devices hosted by at least one server, a first client device receives at least two of an audio session including audio content associated with the online conference, a video session including video content associated with the online conference, and a content session including content associated with the online conference other than audio and video content. A handoff operation is facilitated between the first client device and a second client device such that the second client device receives at least one of the audio session, the video session and the content session from the online conference while the first client device continues to receive at least every other session from the online conference.

### TECHNICAL FIELD

The present disclosure relates to conference sessions between client devices and enabling client device to handoff a conference session to another client device.

### BACKGROUND

Meeting or conference platforms (e.g., a platform facilitating a client/server arrangement) that facilitate scheduling and engaging in conferences with multiple users at client devices have become more frequent due, at least in part, to expanding business horizons within a global economy and the large distances that may exist between participants in meetings. For example, it is much easier and convenient and further less disruptive to workflow to schedule an online meeting or conference session between participants at great distances from each other rather than to arrange a physical meeting in a room with the participants.

Conference platforms as well as client devices have been enhanced over the years to include a number of features and options for meeting participants. For example, participants engaging in a conference can utilize mobile client devices, such as mobile or cellular (smart) phones or note pads in addition to desktop personal computers or laptops, allowing mobility of the participant during a conference session.

It may be desirable at times for a participant using one client device (e.g., a smart phone) to switch or handoff a conference session to another client device (e.g., a desktop or laptop computing device). For example, a participant may have joined a conference session using a smart phone because the participant was away from his or her office. However, when the participant returns to the office, he or she may desire to switch at least a portion of the conference session (e.g., shared content) to a desktop personal computer (e.g., a computing device having a larger display screen). In another example, a participant may have joined the conference session using a desktop or laptop computer. The participant may wish to share video with others in the conference session of his or her office or working environment by switching at least a portion (e.g., video and/or audio content) to a smart phone (or other more portable computing device). A variety of other example scenarios also exist where a participant of an ongoing conference session may desire to switch at least a portion of the conference session from one client device to another.

However, conventional systems are limited in handoff operations in that the entire content of a conference session must be switched from one client device to another during a handoff operation. This can detract from user experience during a conference session.

### BRIEF DESCRIPTION OF THE DRAWINGS

FIG. 1 is a schematic block diagram of an example system that supports a conference platform between client devices which is hosted by conference server(s).

FIG. 2 is a schematic block diagram of an example of a client device connected with for the system of FIG. 1.

FIG. 3 is an example of a conference server system for the system of FIG. 1.

FIG. 4 is a flow chart depicting an example process for performing a handoff of some content of a conference session between two client devices operated by the same user in the system of FIG. 1 and utilizing the techniques described herein.

FIG. 5 is a flow diagram depicting an example embodiment of communications between the client devices and the conference controller of the server system of FIG. 1 utilizing the techniques as described herein.

FIGS. 6 and 7 depict schematic block diagrams showing the handoff of certain content from one client device to another within the system of FIG. 1 utilizing the techniques as described herein.

FIG. 8 depicts an example embodiment for merging of entries for a record maintained by the conference in relation to the client devices depicted in FIGS. 6 and 7 in accordance with techniques described herein.

FIGS. 9-12 depict an example embodiment of an interactive user interface for one of the client devices for the system of FIG. 1, where the user interface facilitates handoff of different types of content from the client device to another client device in accordance with techniques described herein.

### DESCRIPTION OF EXAMPLE EMBODIMENTS

### Overview

Techniques are described herein in relation to an online conference between a plurality of client devices hosted by at least one server. A first client device receives at least two of an audio session including audio content associated with the online conference, a video session including video content associated with the online conference, and a content session including content associated with the online conference other than audio and video content. A handoff operation is facilitated between the first client device and a second client device such that the second client device receives at least one of the audio session, the video session and the content session from the online conference while the first client device continues to receive at least every other session from the online conference.

### Example Embodiments

Meetings presently occur in a number of different environments. With increasing technologies, online conferences can be extended to participants in different locations and utilizing different types of client devices having suitable audio, video and content display capabilities devices to allow participants to effectively communicate with each other via their client devices. As used herein, the term “online conference” or “online conference session” refers to a meeting communication over at least one suitable network and between at least two client devices that can include audio content (provided in an audio session,), video content (provided in a video session) and other content (provided in a content session) such as shared content from one or more presenters in the online conference. Shared content refers to any one or more types of content (e.g., sharing of files or documents, such as word processing documents, spreadsheet documents, slide presentations, etc., sharing of images and the sharing of any other types of content) by a presenter at a client device with other client devices during the online conference, where shared content can include desktop sharing of content in which some or all of the display screen at a client device is shared with other client devices.

Techniques are described herein for facilitating a handoff from one client device to another client during an online conference, where the handoff includes a transfer of at least one of an audio session, a video session and a content session from the one client device to the other while the one client device continues to receive the other sessions that have not been transferred. Each of the audio, video and other content session respectively refer to a data stream comprising audio content, a data stream comprising video content, and a data stream comprising other content associated with an online conference that is provided in an identified session (e.g., a session associated with a user identification) for the client device.

For example, a participant in an online conference and user of two or more client devices configured to engage in the conference may be receiving audio, video and content sessions for the online conference at a first client device, such as a smart phone. The user of the first client device may desire to transfer at least one of the sessions (e.g., the content session) to a second client device, such as a laptop or desktop personal computing device (e.g., to provide a larger display for viewing the content while being able to continue at least the audio session on the user's smart phone). The techniques described herein facilitate such a handoff of a portion of the online conference to a second client device while keeping or maintaining other portions of the online conference at the first client device (e.g., the client device that initiated the handoff operation).

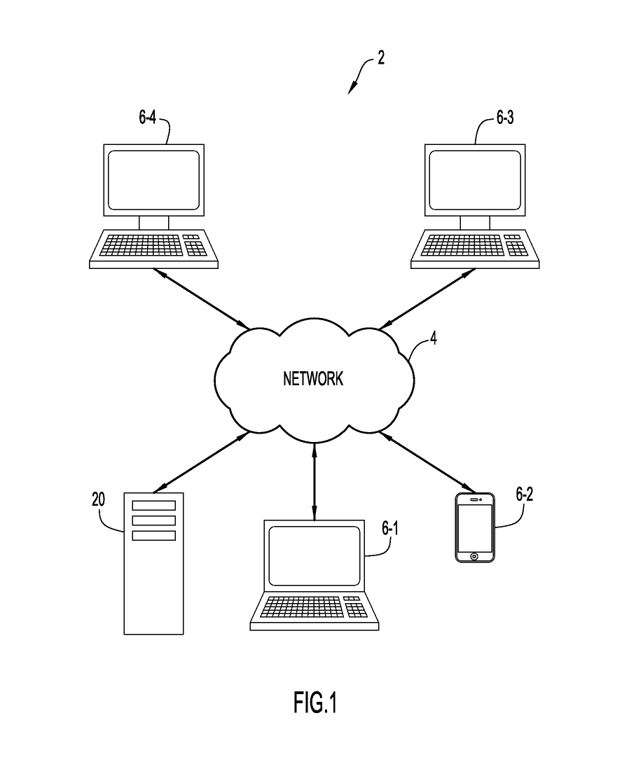

An example embodiment of a system that supports online conferences, including the transmission of audio and video content (via audio and video sessions) and other content (via content sessions), between client devices is depicted in the schematic diagram of FIG. 1. The system comprises a host server system 20 comprising one or more servers. The host server system 20 connects with a plurality of endpoint or client devices 6-1, 6-2, etc. over one or more (designated generally as network 4). The system 2 can support any suitable number and types of client devices 6 engaging in one or more online conference sessions (e.g., two or more online conference sessions occurring simultaneously with different groups of client devices).

The network 4 facilitates communications and exchange of communications and content between client devices 6 via the host server system 2. Examples of types of networks that can be utilized within the system depicted in FIG. 1 include, without limitation, any one or more of local or wide area networks, Internet Protocol (IP) networks such as intranet or internet networks, telephone networks (e.g., public switched telephone networks), wireless or mobile phone or cellular networks, and any suitable combinations thereof.

Any suitable types of client devices 6 may be engaged in an online meeting session at any given time. For example, client devices can include any suitable computing device or computing devices, such as personal computer (PC) devices (including stationary or desktop computers, laptops, etc., such as client devices 6-1, 6-3 and 6-4) or any other suitable types of mobile computing devices (e.g., note pads, tablets, personal data assistant (PDA) devices, cell phones or smart phones, such as client device 6-2, and any other types of portable media player devices). Each of the client devices includes one or more suitable processors, input and output (I/O) devices, memory and software as described herein to facilitate communications with other client devices over the network 4 and via the host server system 20, including engaging in online conferences that include the exchange of audio and video communications as well as the sharing of content.

The host server system 20 can include any suitable number and types of server devices (e.g., one or more server devices) comprising stationary and/or other types of computing devices capable of hosting and managing online conferences and also, optionally, other types of communication sessions between client devices 6 (e.g., email, instant messaging or SMS communications, posting of content in blogs or other virtual environments, support of chat rooms, communities or other forms of social networking platforms).

The client devices and server device(s) of the host server system can utilize any suitable operating systems (e.g., Android, Windows, Mac OS, Symbian OS, RIM Blackberry OS, Linux, etc.) to facilitate interaction, communications and sharing of audio, video and other content between client devices 6 over the network 4. In addition, the techniques described herein for engaging in online conferences can be implemented utilizing any suitable types of commercial software products and associated services that support such communications and sharing of content between client devices. Some examples of software products and associated services with which the techniques described herein can be integrated include, without limitation, WebEx (Cisco Systems, Inc.) and LotusLive (IBM Corporation).

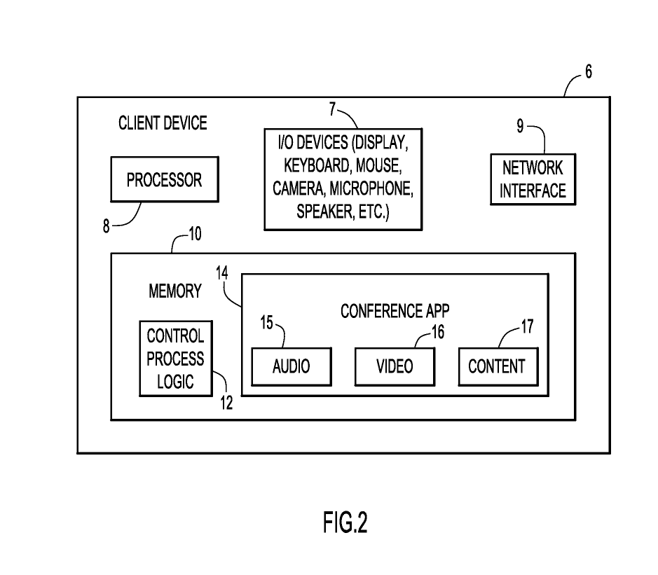

An example embodiment of a client device 6 is depicted in the block diagram of FIG. 2. In particular, the client device 6 includes a processor 8, a network interface 9, a memory 10, and a plurality of input and output (I/O) devices (indicated generally as element 7) including, without limitation, a display device (e.g., LCD or any other suitable type of display screen for displaying video content, images, documents or files and any other types of content), a keyboard, a mouse (or other suitable input control device, e.g., touch pad or touch screen), a camera (e.g., to capture and record still images and video content), a microphone (e.g., to record audio content), speaker(s) (to output audio content), etc. The I/O devices 7 allow the client device to engage in online conferences, including capturing and transmission of audio, video and other content by the client device to other client devices over the network 4 as well as receiving such content during an online conference session.

The network interface 9 of the client device 6 can be, for example, one or more of an Ethernet interface card or switch, a modem, a router or any other suitable hardware device that facilitates a wireless and/or hardwire connection over the network 4 with one or more server devices 20 and other client devices 6, where the network interface unit can be integrated within the device or a peripheral that connects with the device.

The memory 10 of the client device 6 may comprise read only memory (ROM), random access memory (RAM), magnetic disk storage media devices, optical storage media devices, flash memory devices, electrical, optical, or other physical/tangible memory storage devices, and any combinations thereof. The processor 8 can comprise at least one microprocessor that executes control process logic instructions 12 stored within memory 10 including operational instructions and software applications stored within such memory, including operation of a conference application module 14 as described herein. Thus, in general, the memory 10 may comprise one or more tangible (non-transitory) computer readable storage media (e.g., a memory device) encoded with software comprising computer executable instructions and when the software is executed (by the processor 8) it is operable to perform the handoff operations described herein in relation to an online conference.

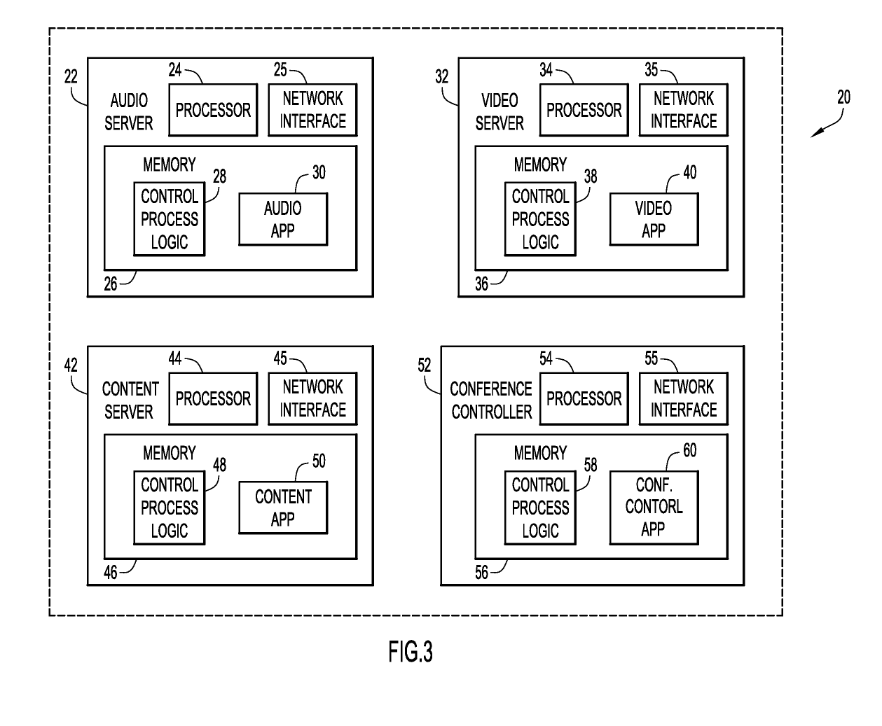

An example embodiment of a host server system 20 that can be used in the system 2 of FIG. 1 is depicted in the block diagram of FIG. 3. The host server system 20 includes an audio server 22, a video server 32, a content server 42 and a conference controller 52, each of which includes a processor 24, 34, 44, 54 and memory 26, 36, 46, 56 that includes control process logic 28, 38, 48, 58 to facilitate performance of operations by the processor for each server in accordance with techniques described herein. Each server 22, 32, 42, 52 further includes a network interface 25, 35, 45, 55 to facilitate communications and/or exchange of content with other computing devices over the network 4. The processors, network interfaces and memories for the servers of the host server system 20 can be of the same or similar types and have the same or similar functionalities as previously described herein in relation to the client device 6. In addition, while the audio server 22, video server 32, content server 42 and conference controller 52 are described and depicted herein as separate computing devices of the host server system 20, it is noted that any two or more of the devices, or any two or more components of any of the devices, can be integrated into a single device or component. Thus, for example, the host server system may be implemented as a single computing device (or any other suitable number of computing devices) that provides the same functions as described herein for the audio server, video server, content server and conference controller.

The conference application module 14 stored in memory 10 of each client device 6 comprises one or more software applications that facilitate online conferences and/or other types of communications with other client devices 6 over the network, where the conferences are hosted by the host server system 20. In particular, the conference application module 14 includes an audio module 15 comprising one or more software applications that communicate with the audio server 22 (via one or more software applications of an audio application module 30 stored in memory 26 of the audio server 22) of the host server system 20 to engage in an audio session during an online conference, where the audio session establishes a connection for the client device 6 to receive audio content from the audio server 22 for the conference session.

The conference application module 14 also includes a video application module 16 comprising one or more software applications that communicate with the video server 32 (via one or more software applications of a video application module 40 stored in memory 36 of the video server 32) to engage in a video session during the online conference, where the video session establishes a connection for the client device 6 to receive video content from the video server 32 for the conference session that is in sync with the audio content of the audio session.

The conference application module 14 further includes a content application module 17 comprising one or more software applications that communicate with the video server 32 (via one or more software applications of a content application module 50 stored in memory 46 of the content server 42) to engage in a content session during the online conference, where the content session establishes a connection for the client device 6 to receive content (e.g., shared desktop content) from the content server 42 for the conference session that is in sync with the audio and video content of the audio and video sessions.

The conference application module 14 also includes one or more suitable software applications that enable communications with the conference controller 52 (via one or more software applications of a conference control application module 60) to facilitate operations associated with the conference session, including providing a user identification for the client device 6 and controlling transmission of audio, video and content sessions from the audio, video and content servers to the client device 6 (or client devices 6) in order to ensure adequate syncing of the sessions as well as handoff operations between client devices utilizing the techniques described herein.

It is noted that any two or more software application modules for the client devices 6 and the host server system 20 can also be combined or integrated into a single one or more software applications while still performing the operations associated with an online conference including handoff of certain portions of the online conference from one client device to one or more other client devices.

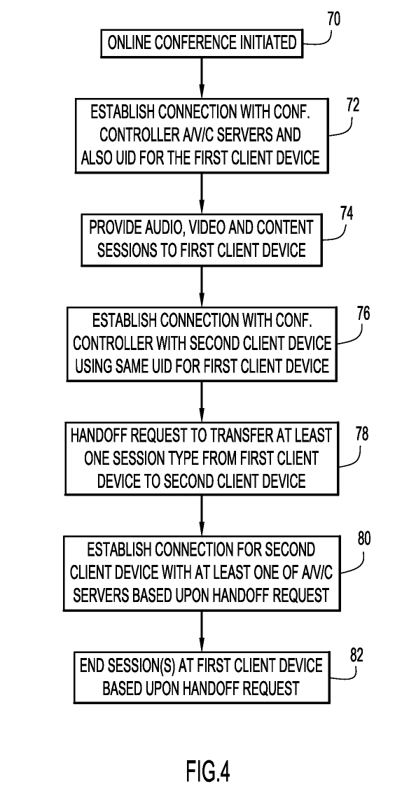

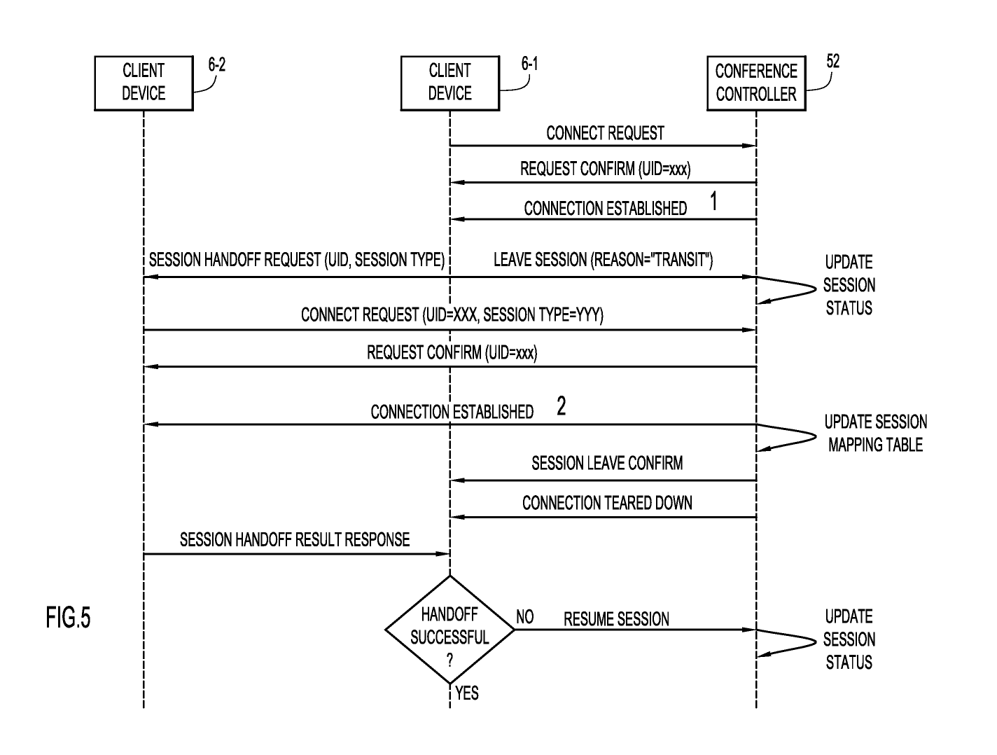

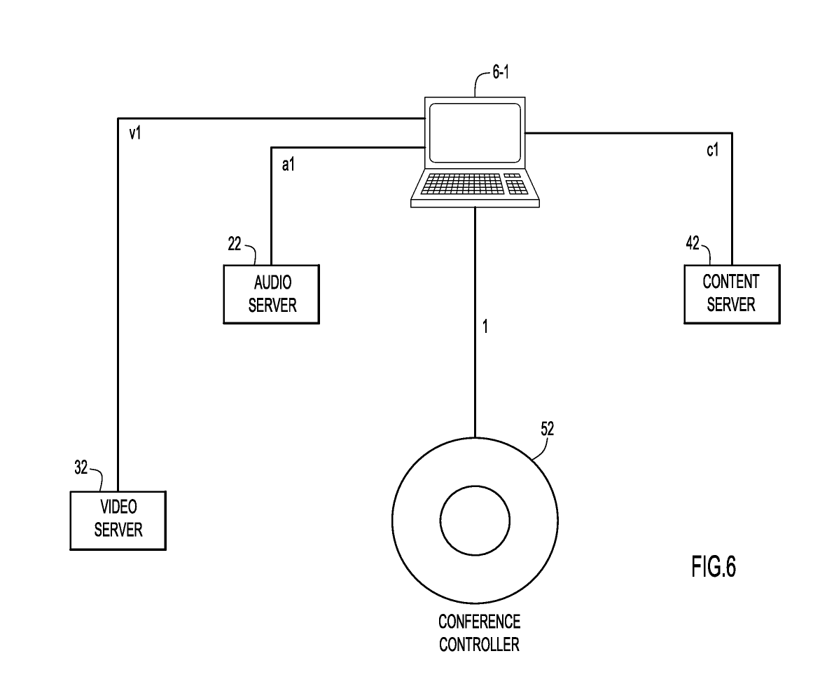

Operation of the system 2 to perform handoff operations between client devices 6 during an online conference is now described with reference to FIGS. 4-8. Referring to FIGS. 4 and 5, an online conference is initiated at 70 (note that FIG. 5 generally describes UID values as ‘XXX’ and session type values as ‘YYY’ in the communication messages between client devices and the conference controller). Client devices 6, which can be of various types (e.g., desktop or laptop personal computing devices, smart phones, note pads, etc.), engage in the conference by connecting with the conference controller 52 so as to receive audio, video and/or other content from the audio, video and content servers 22, 32, 42. Client device 6-1 joins the online conference at 72 (e.g., a conference session that includes client devices 6-3 and 6-4 as depicted in FIG. 1) by making a connection request with the conference controller 52, which includes establishing or registering a user ID (UID) for client device 6-1 in relation to the online conference session (e.g., UID=1 for client device 6-1) and also a connection with the audio server 22, the video server 32 and the content server 42 (where communications and exchange of audio, video and other content is facilitated via the conference application modules of the servers and client device). At 74, after establishing such connections, an audio session a1, a video session v1 and a content session c1 associated with the UID are mapped and provided to client device 6-1 via the servers 22, 32, 42. This is schematically depicted in FIG. 6. The registration of a UID for client device 1 and mapping audio session a1, video session v1 and content session c1 to the UID facilitates control of the audio, video and other content provided to the client device 1 (e.g., ensuring that the audio, video and content sessions are synced with each other) as well as providing other client devices engaged in the online conference session with information that audio, video and other content initiates from client device 1.

At some point during the online conference session, the user of client device 6-1 may desire to switch at least one of the audio, video and content sessions to another client device. For example, where a client device is a laptop or desktop computing device, the user may desire to have greater mobility (e.g., being able to move around a room while still being engaged in the conference session) by switching the audio and/or video sessions to a smart phone or other mobile computing device while leaving the content session at the computing device having a larger display screen. In another example embodiment, a user may have initiated the online conference session with a mobile device, such as a smart phone (e.g., the user initiated the online conference session before arriving at the user's office), but then may desire to switch at least one of the audio, video and content sessions to another client device (e.g., the user arrives at the office and wants to switch the video and/or content sessions to a desktop computing device, while leaving the audio session connected with the smart phone). Any number of possible scenarios exist where a user may desire, after having initiated an online conference at one client device, to split one or more of the audio, video and content sessions of the online conference such that two (or more) client devices receive audio, video and/or content from the online conference.

When the user at client device 6-1 (e.g., a laptop) desires to initiate a handoff of one or more sessions of the online conference session to a second client device 6-2 (e.g., a smart phone), a connection between the conference controller 52 and client device 6-2 is established at 76 using the same UID that has been registered for the first client device 6-1 (e.g., UID=1). For example, a message can be sent from client device 6-1 to client device 6-2 over a suitable device-to-device communication channel that client device 6-2 connect with the conference controller 52 with same UID (UID=1). Alternatively, the system 2 can be configured such that the conference controller 52 connects with client device 6-2, based upon a handoff request from client device 6-1, and registers client device 6-2 with the same UID.

At 78, a session handoff request is communicated to the conference controller 52 to handoff at least one session type (e.g., by specifying UID=1 and session type, a1, v1 and/or c1) to client device 6-2 (now also registered with the conference controller 52 with UID=1). For example, client device 6-1 sends a session handoff notification to client device 6-2 (including session type(s) to be handed off). At about the same time, the client device 6-1 sends a leave session request (reason defined as “transit” of the audio and video sessions, which indicates a handoff is being requested for the audio and video sessions) to the conference controller 52. The conference controller 52 does not immediately process the leave session request from client device 6-1 other than marking the status for such session(s) with a suitable indication that each marked session is to be torn down for client device 6-1. Client device 6-2 also sends a request to the client controller 52 to handoff the designated session(s) to it, e.g., the audio and video sessions.

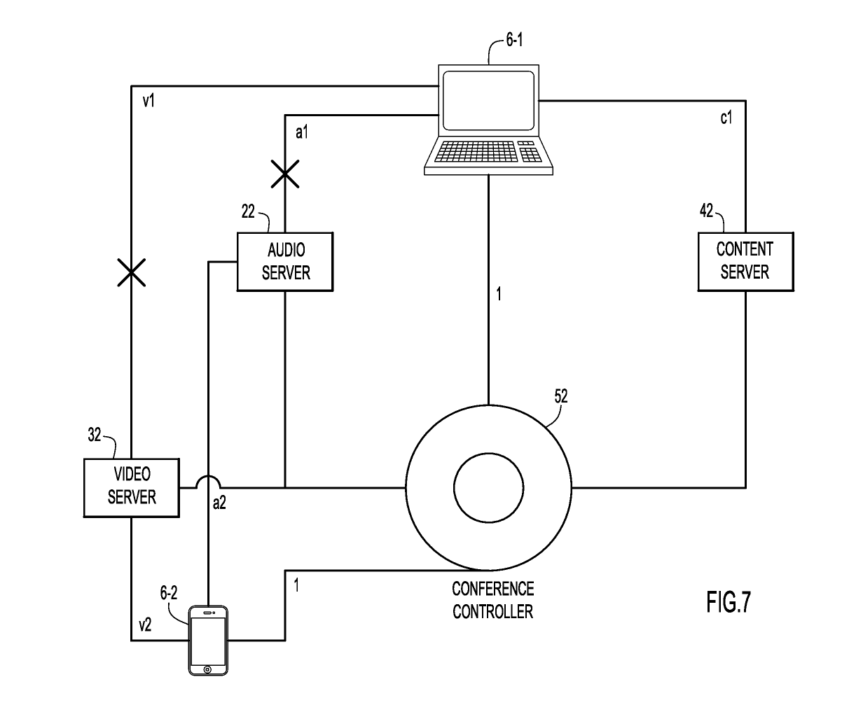

At 80, one or more connections are established between the client device 6-2 and one or more of the audio, video and content servers 22, 32, 42 based upon the processed session handoff request. In the example embodiment, connections are established between client device 6-2 and the audio server 22 and video server 32 with corresponding audio session a2 and video session v2. In particular, the client controller 52, after receiving the request by the client device 6-2 to handoff audio and video sessions associated with UID=1 to client device 6-2, allows such a request based upon the session status (“to be torn down”, reason=“transit”) assigned to the audio and video sessions based upon the previous leave session request by client device 6-1. As depicted in FIG. 7, connections are established between client device 6-2 and audio server 22 and video server 32, with corresponding audio session a2 and video session v2.

At 82, the session(s) of the online conference that have been successfully transferred to client device 6-2 are ended or torn down at the client device 6-1. This is depicted in FIG. 7, in which audio session a1 and video session v1 are torn down and thus terminated at client device 6-1. The result of processing of the handoff request results in one or more portions of the online conference being handled by the first client device (e.g., the content session c1 is associated with client device 6-1) while one or more other portions of the online conference are handled by the second client device (e.g., the audio session a2 and video session v2 are associated with client device 6-2).

It is noted that tearing down of one or more sessions (e.g., audio and video sessions) of the online conference session at client device 6-1 is not implemented by the conference controller 52 unless or until successful connection(s) of such session(s) are established at client device 6-2. This ensures that the flow of audio, video and other content of the online conference is not disrupted to the user during the handoff from the first client device 6-1 to the second client device 6-2.

In the event the handoff request is unsuccessful (e.g., at least one of the sessions requested to be transferred to the second client device cannot be established), any session that has not been successfully transferred to the second client device remains at the first client device. For example, client device 6-2 can notify client device 6-1, via a communication over a suitable device-to-device communication channel, that the handoff was either successful, unsuccessful (e.g., no session transferred to client device 6-2) or partially successful (e.g., some but not all sessions have been transferred to client device 6-2). As depicted in FIG. 5, in response to an indication that the handoff request was not successful, client device 6-1 can send a “resume session” request to the conference controller 52 to reset the session status (e.g., remove the “to be torn down” status) for any one or more of the sessions that have not been successfully transferred to client device 6-2.

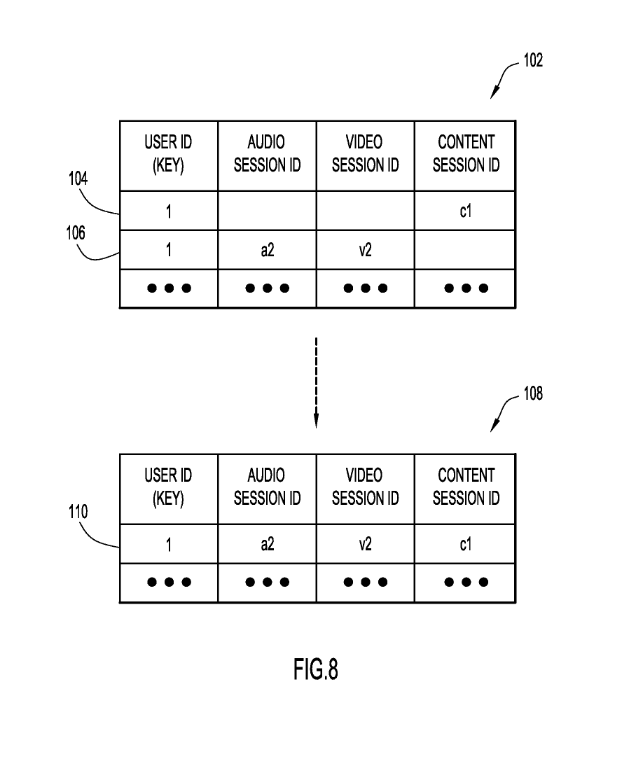

The mapping of audio, video and content sessions with UIDs for client devices can be arranged in a mapping table for an online conference session that can be generated, e.g., by the conference controller 52. The mapping table can further be provided to each client device engaged in the online conference session. An example embodiment of a mapping table 102 is depicted in FIG. 8 with a record 104 providing session information for client device 6-1, including UID values for client devices engaged in the online conference session, as well as corresponding audio session ID values (e.g., a1), video session ID values (e.g., v1) and content session ID values (e.g., c1) associated with the client devices. Prior to the handoff request, client device 6-1 is registered as UID=1 with audio session a1, video session v1 and content session c1, all of which is provided in record 104. While not depicted in table 102, it is noted that each client device engaged in the online meeting session has a record within the mapping table that includes UID and corresponding audio, video and content session information.

After the handoff request to client device 6-2, in which client device 6-1 initiates the handoff request so that client device 6-2 receives audio and video streams while the content stream for the online conference remains with client device 6-1, client device 6-2 is also registered in another record 106 as UID=1 with audio session a2 and video session v2 being transferred to client device 6-2. The mapping table can be revised from table 102 to table 108, as depicted in FIG. 8, so as to merge the records 104, 106 for client device 6-1 and 6-2 into a single record 110 for the same UID. This provides all the session information for a single UID in a single record, regardless of whether there is a single client device or multiple client devices associated with the UID.

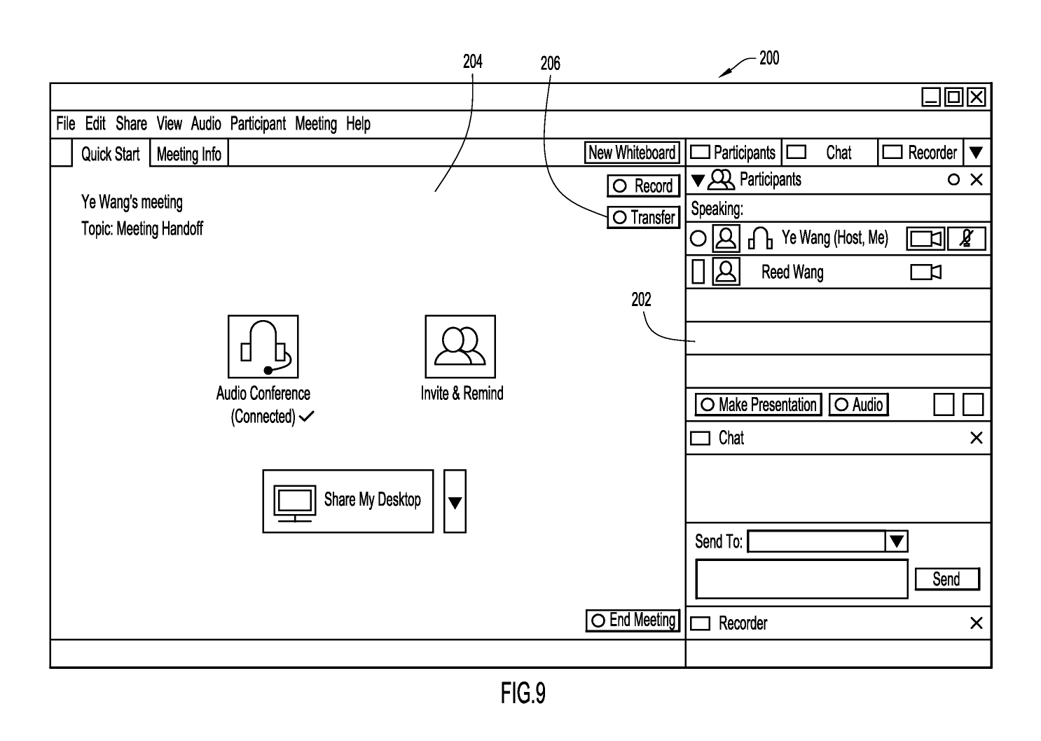

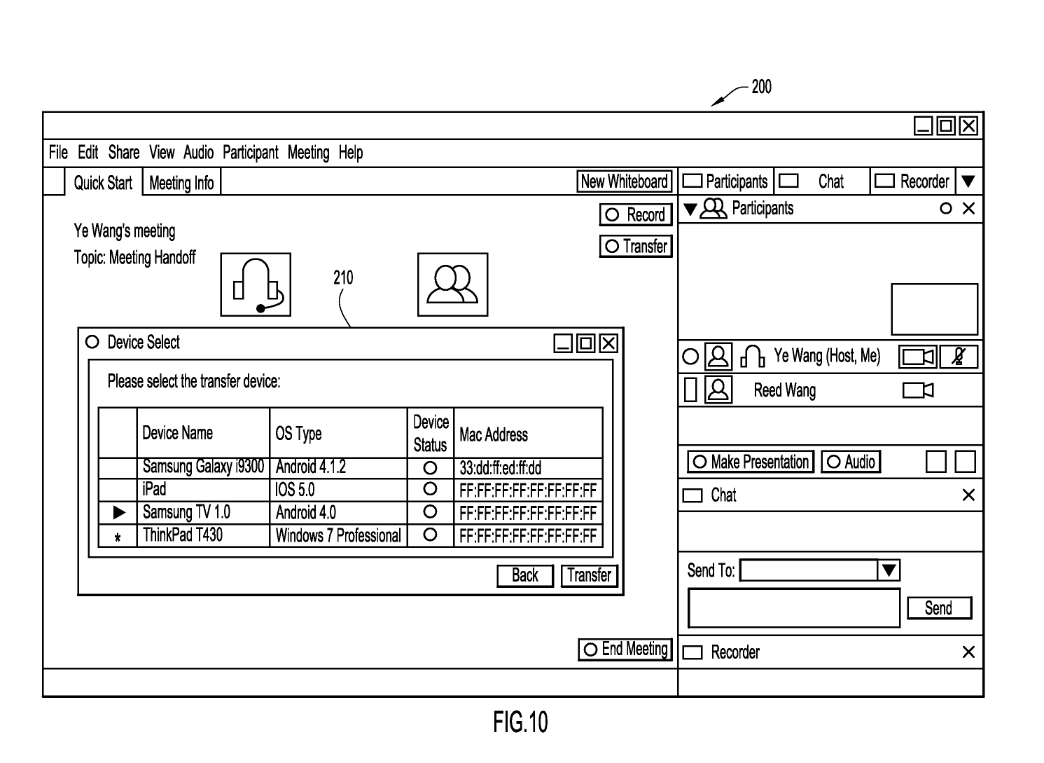

An example embodiment of an interactive user interface for client devices that can be used to implement handoff requests for specific session types is now depicted with reference to FIGS. 9-12. Referring to FIG. 9, a user interface 200 (e.g., implemented via the conference application module 14 of the client device 6-1) that is displayed by client device 6-1 includes a plurality of display windows and input icons (e.g., buttons, scroll bars, menu bars, etc.) that can be of any conventional or other suitable types for facilitating interactive operations for a user of the client device 6-1 in an online conference session with other users. For example, the user interface 200 can include a window 202 that includes a listing of current participants in the online conference (e.g., optionally including other contact or presence information associated with such participants, communication features such as instant messaging that can be initiated with any of the participants, etc.) and a window 204 that displays, e.g., video or other content (e.g., shared desktop content) from video and content sessions associated with the online conference. Any suitable number of other input icons, such as a transfer button 206, can also be provided. The transfer button 206 allows the user of the client device 6-1 to initiate a handoff request of one or more sessions for the online conference.

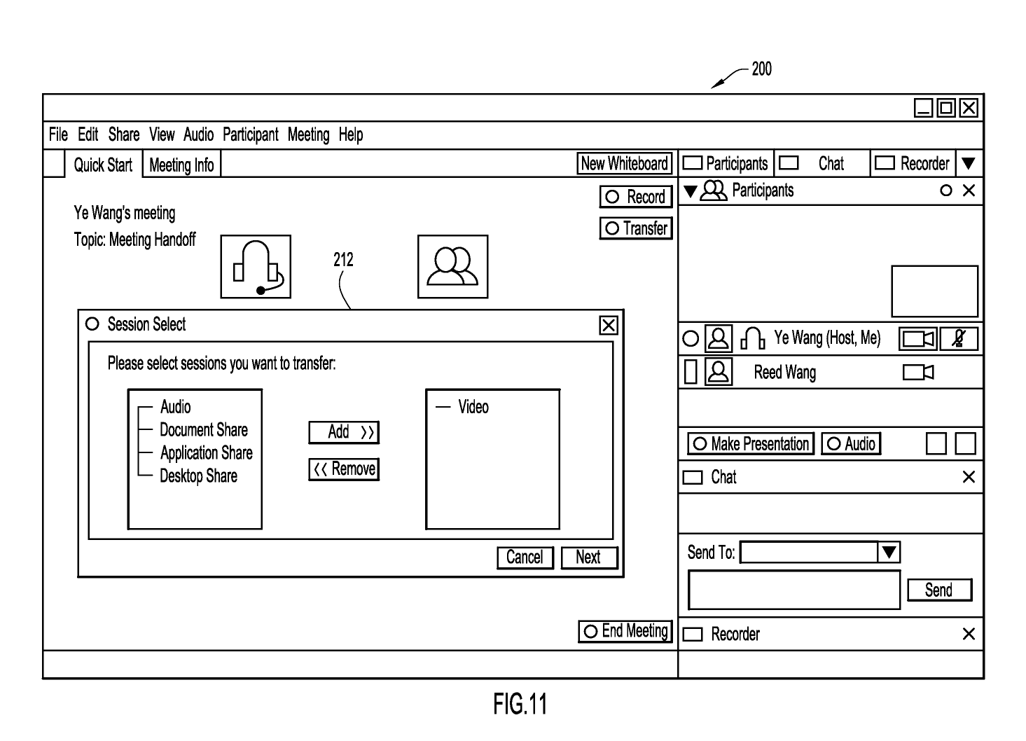

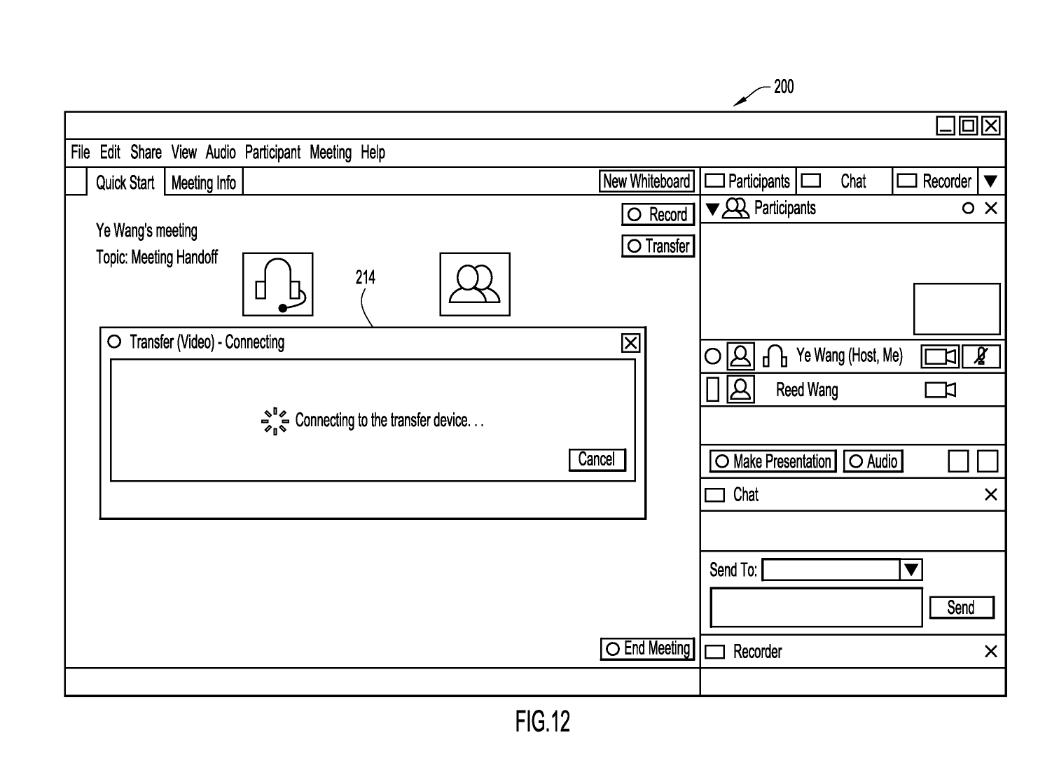

During an online conference, and in response to a user actuating the transfer button 206 (e.g., by clicking on the button via a navigation controllable pointer using a mouse, touch pad or other input control device), a pop-up window 210 appears that lists different client devices also associated with the user from which the user can select to handoff one or more sessions of the ongoing online conference. The list of client devices can be customized to the user's devices, with information associated with each client device (e.g., operating system type, MAC address, etc.) that allows communications to establish the session handoff as previously described herein. In response to selection of a specific client device from the list in window 210, pop-up window 212 depicted in FIG. 11 appears in interface 200. The window 212 provides an option for the user to select one or more sessions (e.g., an audio session, video session, content session) of the online conference session to be transferred to the selected client device. In the example embodiment previously described herein, client device 6-1 can select audio and video sessions in window 212 for handing off or transfer to client device 6-2. In response to making the selections, a window 214 appears in interface 200, as depicted in FIG. 12, which indicates that the handoff process is being implemented. This results in transfer of audio and video content of the ongoing online conference from client device 6-1 to client device 6-2, while any other content (e.g., desktop sharing) associated with the conference is maintained at client device 6-1.

Thus, the techniques described herein facilitate transfer of at least one of audio, video and other content from one client device to at least one other client device during an online conference session. This allows flexibility, e.g., for users who may be on the move or may desire to use a mobile device for certain features (e.g., audio and/or video) and another device for other features of the conference. It is noted that a first client device currently receiving audio, video and other content associated with the online conference can implement a handoff of, e.g., the audio session to a second client device (e.g., a smart phone), and the video session to a third client device (e.g., a note pad) while maintaining the content session at the first client device. In addition, any client device which is a recipient of any one or more handoff sessions of an online conference can also implement a handoff of such session(s) back to the original client device or to a further client device in the same or similar manner in relation to how the original client device implemented the handoff.

Further, while the example embodiments depicted herein describe a tear down or termination of an audio/video/content session at a first client device after transfer of the session to a second client device, in another embodiment the handoff session can also be maintained at the first client device even after the second client device has established a connection to receive the handoff session.

In another example embodiment, a system and corresponding techniques can be implemented to allow a participant to join an online conference session with a plurality of client devices (e.g., the participant registers two or more client devices when joining the online conference)., where each client device is assigned the same UID value and the different sessions assigned to each client device are all mapped (e.g., in a mapping table as described herein) to the same UID.

Another possible scenario that can be implemented utilizing the techniques as described herein includes a split or division of a session (e.g., an audio session or a video session) between two client devices. For example, a first client device may request a handoff operation, utilizing techniques of the type such as described herein, to split the transmission portion of a video session (e.g., video content generated at the first client device that is provided to other client devices engaged in the online conference session) from the receiving portion of the video session (e.g., video content received by the first client device in relation to the online conference session). A split of an audio session or a content session, between the transmission portion and the receiving portion, can also be implemented. Thus, instead of a handoff of the entire session to a second client device, the first client device request a handoff of the designated (transmission or receiving) portion of the session, with the processing techniques for handoff being applied in the same or substantially similar manner based upon communications between first client device, second client device and conference controller to achieve the handoff or transfer of the session portion to the second client device, where both the first and second client devices are again assigned the same UID value. Such division of portions of audio, video and content sessions between two or more client devices assigned the same UID value within an online conference session can also be implemented at the initial stage or joining in of the participant with the online conference (e.g., the participant registers two or more client devices with the same UID when joining the online conference).

The above description is intended by way of example only.

What is claimed is:

1. A method comprising:
during an online conference between a plurality of client devices hosted by at least one server, receiving at a first client device at least two of an audio session including audio content associated with the online conference, a video session including video content associated with the online conference, and a content session including content associated with the online conference other than audio and video content; and
facilitating a handoff operation between the first client device and a second client device such that the second client device receives at least one of the audio session, the video session and the content session from the online conference while the first client device continues to receive at least every other session from the online conference.

2. The method of claim 1, wherein the facilitating the handoff operation further comprises:
in response to the at least one of the audio session, the video session and the content session being transferred to the second client device, terminating the at least one of the audio session, the video session and the content session at the first client device.

3. The method of claim 1, wherein both the first client device and the second client device receive the at least one of the audio session, the video session and the content session after establishing the handoff operation.

4. The method of claim 1, wherein a first user identification (UID) is assigned to the first client device when the first client device is engaged in the online conference, and the facilitating the handoff operation further comprises:
assigning the first UID to the second client device when the second client device is engaged in the online conference.

5. The method of claim 4, wherein the facilitating the handoff operation further comprises:
processing a request at a conference controller to handoff the at least one of the audio session, the video session and the content session between the first client device and the second client device; and
establishing a communication between the conference controller and the second client device using the first UID.

6. The method of claim 5, wherein the facilitating the handoff operation further comprises:
in response to establishing a transfer of the at least one of the audio session, the video session and the content session to the second client device, terminating the at least one of the audio session, the video session and the content session at the first client device; and
in response to a failure to establish a transfer of the at least one of the audio session, the video session and the content session to the second client device, maintaining the at least one of the audio session, the video session and the content session at the first client device.

7. The method of claim 4, further comprising:
establishing a mapping table comprising records for client devices engaged in the online conference, wherein each record comprises a UID and a corresponding audio session ID value, a corresponding video session ID value and a corresponding content ID value; and
in response to establishing a transfer of the at least one of the audio session, the video session and the content session to the second client device, combining the audio session ID value, the video session ID value and the content session ID value for the first and second client devices and the first UID into a single record.

8. The method of claim 1, wherein the facilitating the handoff operation further comprises:
providing a user interface at the first client device to facilitate a request for the handoff operation with the second client device.

9. The method of claim 8, further comprising:
facilitating a selection of the second client device via the user interface from a plurality of different client devices; and
facilitating a selection of at least one of the audio session, the video session and the content session via the user interface.

10. The method of claim 1, wherein the facilitating the handoff operation further comprises:
facilitating the handoff operation between the first client device and a second client device such that the second client device receives one of a transmission portion and a receiving portion of the at least one of the audio session, the video session and the content session from the online conference while the first client device continues to receive the other of the transmission portion and the receiving portion.

11. An apparatus comprising:
at least one memory configured to store instructions including one or more applications that support online conferences between client devices over a network;
a communication interface device configured to enable communications over the network; and
a processor configured to execute and control operations of the one or more applications so as to:
during an online conference between a plurality of client devices, providing to a first client device at least two of an audio session including audio content associated with the online conference, a video session including video content associated with the online conference, and a content session including content associated with the online conference other than audio and video content; and
facilitate a handoff operation between the first client device and a second client device such that the second client device receives at least one of the audio session, the video session and the content session from the online conference while the first client device continues to receive at least every other session from the online conference.

12. The apparatus of claim 11, wherein the processor facilitates the handoff operation by:
in response to the at least one of the audio session, the video session and the content session being transferred to the second client device, terminating the at least one of the audio session, the video session and the content session at the first client device.

13. The apparatus of claim 11, wherein the processor is further configured to execute and control operations of the one or more applications such that both the first client device and the second client device receive the at least one of the audio session, the video session and the content session after establishing the handoff operation.

14. The apparatus of claim 11, wherein a first user identification (UID) is assigned to the first client device when the first client device is engaged in the online conference, and the processor is further configured to execute and control operations of the one or more applications to facilitate the handoff operation by:
assigning the first UID to the second client device when the second client device is engaged in the online conference.

15. The apparatus of claim 14, wherein the processor is further configured to execute and control operations of the one or more applications to facilitate the handoff operation by:
processing a request to handoff the at least one of the audio session, the video session and the content session between the first client device and the second client device; and
establishing a communication with the second client device using the first UID.

16. The apparatus of claim 15, wherein the processor is further configured to execute and control operations of the one or more applications to facilitate the handoff operation by:
in response to establishing a transfer of the at least one of the audio session, the video session and the content session to the second client device, terminating the at least one of the audio session, the video session and the content session at the first client device; and
in response to a failure to establish a transfer of the at least one of the audio session, the video session and the content session to the second client device, maintaining the at least one of the audio session, the video session and the content session at the first client device.

17. The apparatus of claim 14, wherein the processor is further configured to execute and control operations of the one or more applications so as to:
establish a mapping table comprising records for client devices engaged in the online conference, wherein each record comprises a UID and a corresponding audio session ID value, a corresponding video session ID value and a corresponding content ID value; and
in response to establishing a transfer of the at least one of the audio session, the video session and the content session to the second client device, combine the audio session ID value, the video session ID value and the content session ID value for the first and second client devices and the first UID into a single record.

18. One or more computer readable storage media encoded with software comprising computer executable instructions and when the software is executed operable to:
during an online conference between a plurality of client devices hosted by at least one server, receive at a first client device at least two of an audio session including audio content associated with the online conference, a video session including video content associated with the online conference, and a content session including content associated with the online conference other than audio and video content; and
facilitate a handoff operation between the first client device and a second client device such that the second client device receives at least one of the audio session, the video session and the content session from the online conference while the first client device continues to receive at least every other session from the online conference.

19. The computer readable storage media of claim 18, wherein the instructions are further operable to facilitate the handoff operation by:
in response to the at least one of the audio session, the video session and the content session being transferred to the second client device, terminating the at least one of the audio session, the video session and the content session at the first client device.

20. The computer readable storage media of claim 18, wherein the instructions are further operable such that both the first client device and the second client device receive the at least one of the audio session, the video session and the content session after establishing the handoff operation.

21. The computer readable storage media of claim 18, wherein the instructions are further operable to:
assign a first user identification (UID) to the first client device when the first client device is engaged in the online conference; and
assign the first UID to the second client device when the second client device is engaged in the online conference.

22. The computer readable storage media of claim 21, wherein the instructions are further operable to facilitate the handoff operation by:
processing a request at a conference controller to handoff the at least one of the audio session, the video session and the content session between the first client device and the second client device; and
establishing a communication between the conference controller and the second client device using the first UID.

23. The computer readable storage media of claim 22, wherein the instructions are further operable to facilitate the handoff operation by:
in response to establishing a transfer of the at least one of the audio session, the video session and the content session to the second client device, terminating the at least one of the audio session, the video session and the content session at the first client device; and
in response to a failure to establish a transfer of the at least one of the audio session, the video session and the content session to the second client device, maintaining the at least one of the audio session, the video session and the content session at the first client device.

24. The computer readable storage media of claim 21, wherein the instructions are further operable to:
establish a mapping table comprising records for client devices engaged in the online conference, wherein each record comprises a UID and a corresponding audio session ID value, a corresponding video session ID value and a corresponding content ID value; and
in response to establishing a transfer of the at least one of the audio session, the video session and the content session to the second client device, combine the audio session ID value, the video session ID value and the content session ID value for the first and second client devices and the first UID into a single record.
